(19) United States
(12) Patent Application Publication
(10) Pub. No.: US 2026/0285269 A1
(43) Pub. Date: Sep. 24, 2026

(54) BRAKING CONTROL FOR VEHICLES

(71) Applicant: VOLVO TRUCK CORPORATION, Göteborg (SE)

(72) Inventors: Umur ERDINC, Göteborg (SE); Mats JONASSON, Partille (SE)

(73) Assignee: VOLVO TRUCK CORPORATION, Göteborg (SE)

(21) Appl. No.: 19/472,493

(22) PCT Filed: Apr. 13, 2023
(86) PCT No.: PCT/EP2023/059680

§ 371 Date: Oct. 3, 2025

(51) Int. Cl. B60T 8/1755; B60T 8/17; B60T 8/18

(52) U.S. Cl. CPC B60T 8/17554; B60T 8/1708; B60T 8/1887; B60T 2210/12; B60T 2270/60

(57) ABSTRACT

A computer-implemented method for controlling braking of a vehicle combination having a tractor unit and at least one trailing unit is described. The method includes determining a first braking regime for controlling braking of each unit of the vehicle combination using an optimisation function configured to determine a force control input for the vehicle combination, and determining a second braking regime for controlling braking of each unit of the vehicle combination in which each unit has a respective friction utilisation and the friction utilisations are equal.

### TECHNICAL FIELD

The disclosure relates generally to vehicle control. In particular aspects, the disclosure relates to braking control for vehicles, in particular controlling braking of a vehicle combination. The disclosure can be applied in heavy-duty vehicles, such as trucks, buses, and construction equipment, among other vehicle types. In particular, the disclosure can be applied in multi-unit vehicle combinations with distributed propulsion and energy storage. Although the disclosure may be described with respect to a particular vehicle, the disclosure is not restricted to any particular vehicle.

### BACKGROUND

In vehicle motion management, a control system of a vehicle combination may determine control signals for actuators of the vehicle combination in order to satisfy the requested global forces of the vehicle combination. For example, the control system may receive an input related to a manoeuvre for the vehicle combination and determine control signals in the form of propulsion and braking instructions that meet the requested global forces of the vehicle combination subject to certain constraints, for example energy and safety constraints.

In traditional vehicle combinations, for example semi-trailers, a tractor unit may provide propulsion for the entire combination, while trailer units are towed behind. Traditional vehicle combinations may employ internal combustion engines in a tractor unit to provide propulsion. In battery electric vehicle combinations, batteries may be installed in the tractor unit to power electric motors and provide propulsion. If batteries are also installed in the trailer of a vehicle combination, electrical motors may also be installed so that the trailer can be used as a propulsive complement to the combination. This allows the use of an electric trailer with both tractors having internal combustion engines and battery electric vehicle tractors. Furthermore, conventional heavy vehicle trailers are normally installed with pneumatic brakes to make the vehicle stop safely and in time. An electric trailer could also be used to recharge the batteries through regenerative braking, thus preventing wasting energy through the mechanical braking system.

In some implementations, vehicle combinations that operate in this way can be controlled by tailoring a control input in some specific way. For example, it may be desired to minimise power losses, ensure vehicle stability, provide an efficient power distribution, and address many other issues. However, braking control is suboptimal in some scenarios, for example where unsafe braking is implemented, whereas safe braking may not take other factors into account. Current approaches either provide a control input that does not consider safe braking regimes, or provide a braking regime that does not take into account other desired outcomes.

It is therefore desired to develop a solution for vehicle motion management that addresses or at least mitigates some of these issues.

### SUMMARY

This disclosure attempts to address the problems noted above by providing methods for determining a force control input for a vehicle combination based on power losses and force differences associated with units of the vehicle combination. In particular, a first braking regime for controlling braking of each unit of the vehicle combination is determined using an optimisation function, and a second braking regime for controlling braking of each unit of the vehicle combination is determined in which each unit has a respective friction utilisation and the friction utilisations are equal. This enables operation of a vehicle combination to be optimised in some way whilst also enabling equal friction utilisation, which is considered a safe braking regime.

According to an aspect of the disclosure, there is provided a computer-implemented method for controlling braking of a vehicle combination comprising a tractor unit and at least one trailing unit, the method comprising determining a first braking regime for controlling braking of each unit of the vehicle combination using an optimisation function configured to determine a force control input for the vehicle combination, and determining a second braking regime for controlling braking of each unit of the vehicle combination in which the friction utilisations are equal.

This method enables a control input to be tailored in some specific way whilst also providing a safe braking regime where necessary, as equal friction utilisation is considered safer than braking one unit alone or braking units at different levels. For example, a force control input can be determined that minimises power losses, whilst equal friction utilisation can be prioritised when considered necessary.

Optionally, determining the second braking regime comprises applying a constraint to the optimisation function that the friction utilisation of each unit is equal. This enables safer operation of the vehicle combination as friction utilisation is balanced across the units.

Optionally, the computer-implemented method further comprises determining a transition between the first and second braking regimes using linear interpolation. This enables step-like jumps in force requests, which may lead to instabilities, comfort problems and the like, to be avoided.

Optionally, the computer-implemented method further comprises determining a transition between the first and second braking regimes by applying a constraint to the optimisation function such that a difference between the respective friction utilisations tends to zero. This provides a simple mathematical formulation of the transition.

Optionally, determining the second braking regime comprises using the optimisation function such that a difference between the friction utilisation of each unit is below a threshold. This provides a simple mathematical formulation to enable safer operation of the vehicle combination as friction utilisation is balanced across the units.

Optionally, the computer-implemented method further comprises determining a transition between the first and second braking regimes by using the optimisation function such that a difference between the respective friction utilisations tends to zero. This provides a simple mathematical formulation of the transition.

Optionally, the first braking regime is configured to be applied using only electric machine braking of the vehicle combination. This enables regenerative braking, and thus recovery of energy, to be increased.

Optionally, the second braking regime is configured to be applied using electric machine braking and service brakes of the vehicle combination. This enables regenerative braking to be supplemented by the service brakes, thus providing improved safety.

Optionally, the first braking regime is applicable until the braking capacity of electrical machines of all units has been reached. This enables regenerative braking to be used as much as possible, thus maximising energy recovery.

Optionally, the first braking regime is applicable until a safe operating envelope for the vehicle combination has been reached. This enables regenerative braking to be used up to a safe limit, ensuring safe operation of the vehicle combination.

Optionally, the second braking regime is applicable until full friction utilisation for the vehicle combination has been reached. This enables braking to be applied until the full friction is used, thus ensuring safe operation of the vehicle combination.

Optionally, the computer-implemented method further comprises determining the force control input for the vehicle combination comprising a longitudinal braking force input for each unit. This enables an appropriate force control input for each part of the vehicle combination to be determined.

Optionally, the optimisation function is configured to determine the force control input such that a cumulative power loss of the vehicle combination is below a threshold. This enables a reference force input to be met whilst ensuring efficient operation of the vehicle combination.

Optionally, the optimisation function comprises weighting factors associated with each unit of the vehicle combination. This enables the resulting force control input to be tuned for different operating conditions and outcomes.

Optionally, wherein the friction utilisation, Cᵢ, for a unit is given by:

$${C}_{i} = \frac{{F}_{x , i}}{μ \cdot {F}_{z , i}}$$

where, for each unit i, F_{x,i} is a total longitudinal force applied at the axles of the unit, F_{z,i} is a total normal load at the axles of the unit, and u is the friction coefficient between the unit and the travelling surface.

According to another aspect of the disclosure, there is provided a vehicle combination comprising a tractor unit and at least one trailing unit, the vehicle combination comprising processing circuitry to perform the computer-implemented method.

According to another aspect of the disclosure, there is provided a computer program product comprising program code for performing, when executed by processing circuitry, the computer-implemented method.

According to another aspect of the disclosure, there is provided a control system comprising one or more control units configured to perform the computer-implemented method.

According to another aspect of the disclosure, there is provided a non-transitory computer-readable storage medium comprising instructions, which when executed by processing circuitry, cause the processing circuitry to perform the computer-implemented method.

According to another aspect of the disclosure, there is provided a computer system comprising processing circuitry configured to perform the computer-implemented method.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognised by practicing the disclosure as described herein. There are also disclosed herein control units, computer readable media, and computer program products associated with the above-discussed technical benefits.

### BRIEF DESCRIPTION OF THE DRAWINGS

With reference to the appended drawings, below follows a more detailed description of aspects of the disclosure cited as examples.

FIG. 1 schematically shows a side view of an example vehicle combination.

FIG. 2 schematically shows a top-view of an example vehicle combination.

FIG. 3 schematically shows, in terms of functional blocks, an example control system for a vehicle combination.

FIGS. 4A-D are example plots of friction utilisation for a vehicle combination comprising a tractor unit and a semi-trailer trailing unit.

FIG. 5 is a flowchart of an example method for controlling braking of a vehicle combination.

FIG. 6 is a schematic diagram of an exemplary computer system for implementing examples disclosed herein, according to one example.

FIG. 7 is a schematic drawing of a computer readable medium according to one example.

FIG. 8 is a schematic block diagram of a control unit according to one example.

Like reference numerals refer to like elements throughout the description.

### DETAILED DESCRIPTION

Aspects set forth below represent the necessary information to enable those skilled in the art to practice the disclosure.

In vehicle combinations having a plurality of units, for example a tractor unit and one or more trailer units, it is often desired to tailor a control input in some specific way. For example, it may be desired to minimise power losses, ensure vehicle stability, provide an efficient power distribution, and address many other issues. However, it is also important to operate the vehicle combination in a safe manner. Certain other factors may however be neglected in such approaches. For example, these approaches may not take braking regimes of the vehicle combination into account when providing a control input for a vehicle combination. Similarly, the determination of braking regimes may not take into account the various other desired outcomes. There is currently no solution that enables operation of a vehicle combination to be optimised in some way whilst also ensuring adequate operation of the brakes.

To remedy this, methods and systems are proposed for controlling braking of a vehicle combination comprising a tractor unit and at least one trailing unit. A method comprises determining a first braking regime for controlling braking of each unit of the vehicle combination using an optimisation function configured to determine a force control input for the vehicle combination. A second braking for controlling braking of each unit of the vehicle combination regime is determined in which the friction utilisation of each unit is equal. As equal friction utilisation is considered safer than braking one unit alone or braking units at different levels, this approach enables a control input to be tailored in some specific way whilst also providing a safe braking regime where necessary.

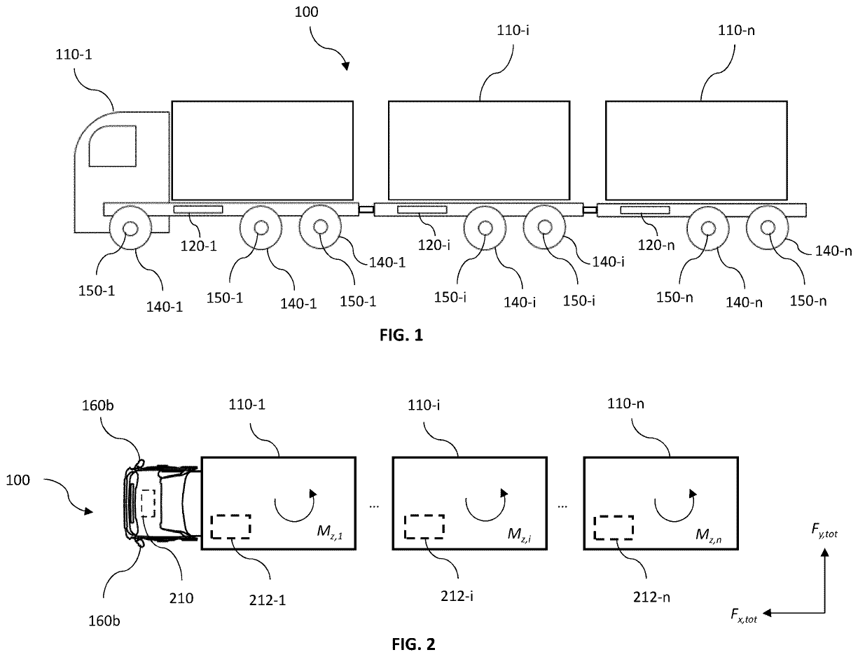

FIG. 1 schematically shows a side view of an example vehicle combination 100 of the type considered in this disclosure. The vehicle combination 100 comprises a number of units 110, including a tractor unit and at least one trailing unit. Each unit 110 may be given an index i, and the total number of units 110 in a vehicle combination 100 is designated n. Whilst two trailing units are shown, it will be appreciated that the vehicle combination 100 may comprise more or fewer trailing units connected to each other. This gives rise to different types and designations of vehicle combinations.

A tractor unit, such as the tractor unit 110-1, is generally the foremost unit in a vehicle combination 100, and may comprise the cabin for the driver, including steering controls, dashboard displays and the like. Generally, the tractor unit 110-1 is used to provide propulsion power for the vehicle combination 100. In the example of FIG. 1, the tractor unit 110-1 may also be used to store goods that are being transported by the vehicle combination 100.

A trailing unit, such as the trailing units 110-i, 110-n, is generally used to store goods that are being transported by the vehicle combination 100. A trailing unit may be a truck, trailer, dolly and the like. A trailing unit may also provide propulsion to the vehicle combination 100. A trailing unit without a front axle, such as the trailing units 110-i, 110-n, is known as a semi-trailer. In vehicle combinations such as that shown in FIG. 1, vehicle motion management is available on a unit level to receive requests from a manual or virtual driver to coordinate the propulsion, braking and steering. All units 110 may provide propulsion to the vehicle combination 100.

Whilst three tractor axles and two axles per trailer are shown, it will be appreciated that any suitable number of axles may be provide on the respective units 110. It will also be appreciated that any number of the tractor axles and/or trailer axles may be driven axles, including zero (i.e. one of the units may include at least one driven axle while the other does not).

The vehicle combination 100 may comprise one or more sources or propulsion. For example, on or more of the units 110 may comprise one or more electrical machines 130 (not shown) such as electric motors. Each unit 110 may comprise one or more batteries 120 configured to provide power to the electrical machines 130. In some examples, a unit 110, most often a tractor unit 110-1, may also include another source of propulsion, for example an internal combustion engine (ICE). The vehicle combination 100 also comprises a drivetrain (not shown) to deliver mechanical power from the propulsion source (the electrical machines 130 or the ICE) to the wheels 140.

The electrical machines 130 are configured to drive, e.g. provide torque and/or steering to, one or more axles or individual wheels 140 of the unit 110. The electrical machines 130 of a unit 110 can supply either a positive (propulsion) or negative (braking) force. In some examples, electric motors may also be operated as generators, in order for the electric motors to generate braking force when required. The use of electrical machines 130 to supply a negative force is known as regenerative braking. The energy recovered from regenerative braking can be stored in the batteries 120, and so regenerative braking is generally preferred over using service brakes 150.

Furthermore, each unit 110 may comprise one or more sets of service brakes 150. The service brakes 150 of a unit 110 can supply a negative (braking) force. The service brakes 150 may be, for example, frictional brakes such as pneumatic brakes. Pneumatic brakes use a compressor to fill the brake with air, which may be powered by the batteries 120. In some examples, the brakes may be electro-mechanical brakes.

The ICE, electrical machines 130 and service brakes 150 are considered as actuators of the vehicle combination 100. Other actuators may also be present, such as steering servo arrangements. Each actuator in a given unit 110 may be given an index k, and the total number of actuators in a given unit 110 is designated m.

The vehicle combination 100, or indeed one or more (e.g. each) units 110, can be considered to comprise two systems: a propulsion system comprising the components that are involved in propulsion of the vehicle combination 100, and a braking system comprising the components that are involved in braking of the vehicle combination 100. As such, the propulsion system can be considered to comprise one or more of the ICE, electrical machines 130, the drivetrain, and batteries 120 of the vehicle combination 100, while the braking system can be considered to comprise the electrical machines 130, the drivetrain, the batteries 120, and the service brakes 150. As such, there is some overlap between the propulsion system and the braking system.

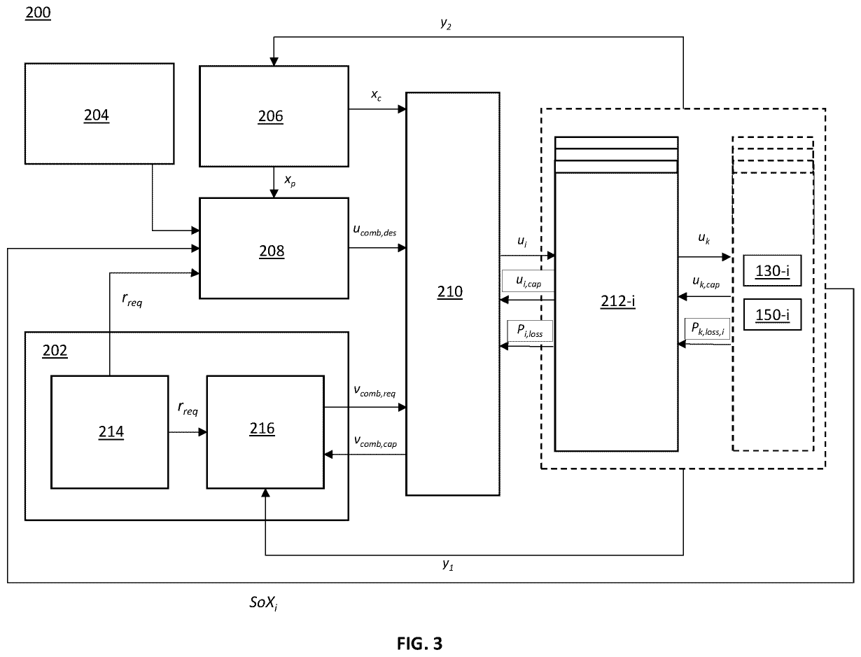

FIG. 2 schematically shows a top-view of an example vehicle combination 100 of the type considered in this disclosure. Similarly to the example of FIG. 1, the vehicle combination 100 comprises a number of units 110, including a tractor unit and a plurality of trailing units. FIG. 2 also shows the requested global forces of the vehicle combination 100 as a whole. Examples of requested global forces of the vehicle combination 100 as a whole may e.g. include a total longitudinal/axial force F_{x,tot} a total lateral/radial force F_{y,tot}, and/or one or more yaw moments M_{z,i} for the respective vehicle units 110. In order to control motion of a vehicle combination 100, the requested global forces of the vehicle combination 100 must be determined and resolved. This may be achieved by a control system 200 (shown in FIG. 3) of the vehicle combination 100 that determines control signals based on a requested reference input and certain operating conditions of the vehicle combination 100.

In the example of FIG. 2, the vehicle combination 100 includes a combination control allocator 210 and a plurality of unit control allocators 212. The combination control allocator 210 and the various unit specific control allocators 212 together form a distributed control allocation system for the vehicle combination 100. In this system, the control allocation may be performed on multiple levels, i.e. first on a level of the vehicle combination 100 as a whole, and then on a level of each vehicle unit 110 individually. The combination control allocator 210 may be provided (as shown) as part of the tractor unit 110-1, while the unit control allocators 212 are provided as part of each individual unit 110. It will be appreciated that the combination control allocator 210 may be provided as part of any unit 110 of the vehicle combination 100.

FIG. 3 schematically shows, in terms of functional blocks, an example control system 200 for a vehicle combination 100. The control system 200 serves to perform various functions of the vehicle combination 100, such as power management and motion coordination. The control system 200 comprises a target generator 202, a tactical layer 204, a state estimator 206, an energy manager 208, a combination control allocator 210 and a plurality of unit control allocators 212. The various modules may e.g. be implemented as code running on a processing circuitry, or similar. The various modules may be communicatively connected or connectable to each other, for example as known in the art.

The purpose of the target generator 202 is to determine a requested reference input r_{req} and a virtual control input v_{comb,req} for the vehicle combination 100. The requested reference input r_{req} is determined based on an input related to a manoeuvre for the vehicle combination 100 and represents a requested movement of the vehicle combination 100. The virtual combination control input v_{comb,req} is determined based on the requested reference input r_{req} and a motion capability v_{comb,cap} for the vehicle combination 100. The target generator 202 comprises a path planner/controller 214 and a force generator 216.

The target generator 202 may receive an input related to a manoeuvre for the vehicle combination 100. The manoeuvre may be, for example, straight-line driving, cornering, braking and the like. The target generator 202 may receive a signal from, for example, a steering wheel and/or gas/brake pedal of the combination 100, indicating that the driver (or some other system of the vehicle combination 100) wants to change the direction and/or the speed of the vehicle combination 100 in a certain way. In some examples, the signal may originate from elsewhere, for example any other system that may provide some indication of how the overall forces of the vehicle combination 100 are to be influenced (e.g. steered, propelled or braked). For example, the signal may originate from a lane assist system, a lane following system, an emergency steering system, an emergency braking system, an automated or semi-automated drive system. Based on this input, the target generator 202 outputs a requested reference input r_{req}. In particular, the path planner/controller 214 determines the requested reference input r_{req}. The requested reference input r_{req} may comprise at least one of a longitudinal acceleration aₓ of the vehicle combination 100 as a whole or of a unit 110 of the vehicle combination 100 (for example the unit 110 comprising the combination control allocator 210), a longitudinal velocity vₓ₁ of the tractor unit 110-1, a lateral velocity v_{y1} of the tractor unit 110-1, a yaw rate ω_{zi} of at least one unit 110 of the vehicle combination 100, and a steering angle δ_{f,req} of the tractor unit 110-1.

The virtual combination control input v_{comb,req} is determined based on the requested reference input r_{req}. In particular, the force generator 216 determines the virtual combination control input v_{comb,req}. The virtual combination control input v_{comb,req} may include requested motion parameters for the vehicle combination 100. In particular, the forces F_{tot,req} and/or moments M_{z,tot,req} that need to be applied to the vehicle combination 100 as a whole in order to follow the requested reference input r_{req} are determined. The requested motion parameters included in the combination virtual control input v_{comb,req} of the vehicle combination 100 may comprise at least one of a longitudinal force F_{x,tot,req} of the vehicle combination 100, a lateral force F_{y,tot,req} of the vehicle combination 100, a longitudinal coupling force F_{cxi,req} between consecutive units 110, a lateral coupling force F_{cyi,req} between consecutive units 110. These make up the total force to be applied F_{tot,req} for the vehicle combination 100. The requested motion parameters included in the combination virtual control input v_{comb,req} of the vehicle combination 100 may comprise a yaw moment M_{z,i,req} for one or more units 110.

The virtual combination control input v_{comb,req} may also be determined based on state information y₁ from the different units 110 of the vehicle combination 100 and a motion capability v_{comb,cap} for the vehicle combination 100. The state information y₁ may include information from sensors of the vehicle combination 100 such as wheel speed sensors, inertial measurement units, articulation angle sensors and the like. The motion capability v_{comb,cap} of the vehicle combination 100 may describe the limits of motion parameters for safe operation of the vehicle combination 100. The motion capability v_{comb,cap} may comprise at least one of a longitudinal force F_{x,tot,cap} of the vehicle combination 100, a lateral force F_{y,tot,cap} of the vehicle combination 100, and a yaw moment M_{z,i,cap} for one or more units 110.

The virtual combination control input v_{comb,req} may be determined based on a vehicle model. The vehicle model can be any suitable model, for example a model known in the art. The model can be based on real tests, computer model simulations, a machine-learning model, or other suitable means known in the art. The vehicle model may provide motion prediction of the vehicle combination 100 by looking at previous steering input and acceleration input. The prediction may include instabilities such as understeer or rollover risk, for example within a one second horizon. The model may be, for example, a single-track model, i.e., left and right wheels on a given axle are considered together. The real units can have axle groups with several axles, but in the model they are considered together. A tyre model can be used in combination with the vehicle model. The tyre model may take into account the cornering stiffness of the tyres of the vehicle combination 100.

The tactical layer 204 is responsible for ensuring that the trajectory for the whole combination 100 is obstacle free and collision free. The tactical layer 204 may also provide a requested reference input in an autonomous driving case. The tactical layer 204 may also include predictive energy management, including battery targets, capabilities and statuses that determine how the energy sources of the vehicle combination 100 should be used for a whole mission.

In some examples, the tactical layer 204 can decide on state of charge (SoC) targets for the batteries 120 of the vehicle combination 100 as a function of distance, in some cases considering slope changes, etc. For example, the tactical layer 204 can request the battery 120 of a unit 110 having a higher SoC be drained for an uphill slope, as it can foresee that batteries 120 of all units 110 can be charged fully with regenerative braking at a following downhill slope. In some examples, an SoC controller (not shown) can calculate weighting factors for SoC targets. In some examples, the tactical layer 204 can send targets for the state of energy rate (S\dot{o}E) directly to the combination control allocator 210.

Furthermore, the tactical layer 204 can request the transfer of energy from one unit 110 to another by means of propulsion in one unit 110 and regenerative braking in the other (as explained in WO 2021/180300 A1 in the name of Volvo Truck Corporation). In another example, the tactical layer 204 request the battery 120 of a unit 110 be drained faster than another based on the number of available chargers in a following charge station or due to equalizing the charging time of all units 110 or minimizing the total charging time at the charging station.

The state estimator 206 is responsible for processing state information y₂ from the different units 110 of the vehicle combination 100. For example, the state estimator 206 may receive information from sensors of the vehicle combination 100 such as wheel speed sensors, inertial measurement units, articulation angle sensors and the like and use this information to determine states for the vehicle combination 100 and the various units. The state estimator 206 may then output unit-specific state information xₚ to the energy manager 208 and unit-specific state information x_{c} to the combination control allocator 210.

The energy manager 208 determines a power split between the different units 110 of the vehicle combination 100. The energy manager 208 may also determine a power split within each unit 110, meaning how the power demand is divided between the actuators (for example, the ICE, the electrical machines 130, service brakes 150, and/or steering servo arrangements) of the unit 110. Inputs to the energy manager 208 include the requested reference input r_{req} from the target generator 202 and the statuses SoX of the batteries 120 of the vehicle combination 100. The energy manager 208 determines a power allocation and an associated power allocation input u_{comb,des}. The power split may be determined based on the state of energy rate (S\dot{o}E) for each unit 110 and/or the longitudinal part of the requested force for the unit's propulsion system F_{xpi,req}. The energy manager 208 may consider factors that affect long-term energy consumption, such as road slopes, SoC states, charger locations, and the like, and determine power behavior as a function of the energy over time.

Based on these values, the control allocators 210, 212 may determine control signals that meet the requested global forces of the vehicle combination 100 to meet certain constraints, such as power management (optimising battery usage) and safety constraints (ensuring that the trajectory for the whole combination 100 is obstacle free and collision free). In particular, the control allocators 210, 212 determine how various actuators (for example, the ICE, the electrical machines 130, service brakes 150, and/or steering servo arrangements) of the vehicle combination 100 are to be controlled in order to generate requested global forces of the vehicle combination 100 as a whole. The combination control allocator 210 and the various unit specific control allocators 212 together form a distributed control allocation system for the vehicle combination 100. In this system, the control allocation is performed on multiple levels, i.e. first on a level of the vehicle combination 100 as a whole, and then on a level of each vehicle unit 110 individually.

The combination control allocator 210 transforms the virtual combination control input v_{comb,req} from the target generator 202 into a true control input u_{comb} for the vehicle combination 100, describing appropriate motion parameters for each unit 110. The combination control allocator 210 also transforms the true combination control input u_{comb} into unit-specific virtual control inputs uᵢ describing the forces that each respective unit 110 is to produce in order to provide the true control input u_{comb} of the vehicle combination 100. The true control input u_{comb} of the vehicle combination 100 comprises the force F to be applied for the vehicle combination 100. The unit-specific virtual control inputs uᵢ may comprise a virtual force control input for the unit's propulsion system F_{pi,req} and a virtual force control input for the unit's braking system F_{bi,req}.

The unit control allocators 212 comprise a specific control allocator 212 for each unit 110 of the vehicle combination 100. The unit-specific virtual control inputs uᵢ that are output from the combination control allocator 210 are transformed into unit-specific true control inputs uₖ, describing actual actuator commands by the unit-specific control allocators 212. For example, the unit-specific control allocators 212 map the forces and moments of each unit 110 into the steering and drive/brake torques to be applied at the wheels 140 of each unit 110. To do this, the unit control allocators 212 determine virtual force control inputs for the individual actuators of the unit's different systems: F_{pk,req} for the actuators of the propulsion system, and F_{bk,req} for the actuators of the braking system. The unit control allocators 212 then determine the unit-specific true control inputs uₖ accordingly, which comprise a true force control input for the unit's propulsion system Fₚᵢ and a true force control input for the unit's braking system F_{bi}. These may respectively include true force control inputs for the individual actuators of a unit: Fₚₖ for the unit's propulsion actuators and F_{bk} for the unit's braking actuators.

In some examples, each unit 110 may be capable of estimating its own capabilities u_{i,cap}, e.g. how much and/or how fast the unit can move at a current time instant. The unit capabilities comprise a force capability for its propulsion system F_{pi,cap} and a force capability for its braking system F_{bi,cap}. This may be based on an actuator capability u_{k,cap} for each actuator, e.g. how much and/or how fast the unit can move at a current time instant. The actuator capabilities comprise a force capability for the actuators F_{pk,cap} during propulsion and a force capability for the actuators F_{bk,cap} during braking. The actuators of each unit 110 may provide an actuator capability u_{k,cap} to the respective unit control allocator 212-i, which provides a unit capability u_{i,cap} to the combination control allocator 210. The unit capabilities u_{i,cap} may also comprise capabilities of the power input/output of the batteries 120.

Each unit 110 may also be capable of estimating its own power losses P_{i,loss}. The unit power losses P_{i,loss} comprise a power loss for its propulsion system P_{pi,loss} and a power loss for its braking system P_{bi,loss}. This may be based on an actuator power losses P_{k,loss,i} for each actuator in the unit as well as other power losses in the unit 110, such as power losses in the batteries and the drivetrain. The actuator power losses P_{k,loss,i} comprise a power loss for propulsion actuators P_{pk,loss,i} (e.g. electrical machines 130, ICE, and/or other propulsion sources) and a power loss for braking actuators P_{bk,loss,i} (e.g. electrical machines 130 and/or service brakes 150). The actuators of each unit 110 may provide the actuator power losses P_{k,loss,i} to the respective unit control allocator 212-i, which provides unit power losses P_{i,loss} to the combination control allocator 210.

The control system shown in FIG. 3 is capable of controlling motion of a vehicle combination 100 in a number of ways. In particular, a force control input can be determined for the vehicle combination 100 that is tailored in some specific way.

For example, a force control input may be determined such that a cumulative power loss of the vehicle combination 100 is below a threshold. For example, an acceptable value for the total power losses P_{loss,comb} of the vehicle combination 100 can be determined and implemented as an upper limit for the power losses. The force control input can then be determined such that the cumulative power losses of the vehicle combination 100 are below that value. This can be achieved using an optimisation function to minimise the cumulative power losses of the vehicle combination 100. Alternatively, this can be achieved, for example, using rule-based methods of machine learning methods. This approach is disclosed in detail in PCT application no. PCT/EP2023/059640 filed on the same day as this application in the name of Volvo Truck Corporation, and is briefly summarised below.

In this approach, the total power losses P_{loss,comb} in the vehicle combination 100 can be expressed as:

$${P}_{loss , comb} = {\sum }_{i = 1}^{n} ( {P}_{pi , loss} ( {F}_{pi} ) + {P}_{bi , loss} ( {F}_{bi} ) ) \qquad ( 1 )$$

In some examples, the total power losses P_{loss,comb} include power losses from an internal combustion engine, the batteries 120, the electrical machines 130, the drivetrain, and/or the service brakes 150 of the vehicle combination 100. An acceptable value for the total power losses P_{loss,comb} of the vehicle combination 100 can be determined and implemented as an upper limit for the power losses. The force control input can then be determined such that the total power losses of the vehicle combination 100 are below that value.

In the following, only the longitudinal part of the force, Fₓ, is considered for simplicity. However, it will be appreciated that other components of the force can be considered. For example, lateral forces and yaw moments can be obtained indirectly from differential braking and propulsion. Steering control can also be taken into account.

The force control input Fₓ comprises the propulsion and braking components of the force for each unit. As such, the force control input Fₓ can be formulated as:

$${F}_{x} = [ {F}_{xp 1} , {F}_{xb 1} , {F}_{xp 2} , {F}_{xb 2} , ... , {F}_{xpn} , {F}_{xbn} ] \qquad ( 2 )$$

where Fₓₚᵢ is the longitudinal part of the force applied by the unit's propulsion system, and F_{xbi} is the longitudinal part of the force applied by the unit's braking system.

An optimisation function to minimise the cumulative power losses may be formulated based on equation (1), and given as follows:

$${min}_{{F}_{x}} {\sum }_{i = 1}^{2 n} ( {P}_{pi , loss} ( {F}_{xpi} ) + {P}_{bi , loss} ( {F}_{xbi} ) ) \qquad ( 3 )$$

The optimisation function in equation (3) serves to minimise the cumulative power losses from the units 110 of the vehicle combination 100. The optimisation function operates by modelling different force control inputs and determining which minimises the function. It has been found that the optimisation function is typically can be approximated as second order (quadratic) and there are efficient numerical methods to solve this problem.

In some examples, a difference between requested forces and allocated forces across the vehicle combination 100 is taken into account as well as the power losses. The requested force input for one or more units of the vehicle combination 100 from the reference input. The requested force input can be given by the unit-specific virtual control inputs uᵢ. The requested force input may comprise a force input for the unit's propulsion system F_{xpi,req} and a force input for the unit's braking system F_{xbi,req}. The force difference can be determined for both the propulsion system (F_{xpi,req}−Fₓₚᵢ) and the braking system (F_{xbi,req}−F_{xbi}).

In this case, a force control input is determined such that a cumulative power loss of the vehicle combination 100 and the difference between the requested force and the allocated force of the vehicle combination 100 are below a threshold. An optimisation function to minimise the cumulative power losses and force difference may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {( {F}_{xpi , req} - {F}_{xpi} )}^{2} + {( {F}_{xbi , req} - {F}_{xbi} )}^{2} ) \qquad ( 4 )$$

It is noted that the difference terms in equation (4) are squared. This is typical in such error calculations, although not essential, and the different terms may be first order terms or a square-root of summations of squared errors. By using second order terms, the negative and positive errors are penalised equally, and larger errors are penalised more than smaller errors.

The optimisation function in equation (4) serves to minimise the cumulative power losses from the units 110 of the vehicle combination 100 as well as minimising the difference between requested forces and allocated forces. By minimising the force difference, it can be ensured that the vehicle combination 100 is accurately following the requested motion input. For example, for a jack-knifing vehicle combination 100 due to too much tractor braking, the requested forces can be set as zero or small, and the minimisation of the function would be achieved by braking a trailer unit 110-i more and tractor unit 110-1 less. This approach is disclosed in detail in PCT application no. PCT/EP2023/059642 filed on the same day as this application in the name of Volvo Truck Corporation.

In some examples, a difference between the requested state of energy rate S\dot{o}E_{i,req} and the allocated state of energy rate S\dot{o}Eₜ across the vehicle combination 100 is taken into account as well as the power losses. The requested state of energy rate S\dot{o}E_{i,req} can be given by F_{xpi,req}·v_{xi,req}, where v_{xi,req} is the requested longitudinal velocity of unit i (or indeed Fₓₚᵢ,req·vₓᵢ, where vₓᵢ is the longitudinal velocity of unit i). The state of energy rate S\dot{o}Eᵢ allocated to one or more units of the vehicle combination 100 can be expressed as Fₓₚᵢ·vₓᵢ, and so it is also a function of Fₓₚᵢ.

In this case, a force control input is determined such that a cumulative power loss of the vehicle combination 100 and the difference between the state of energy rate S\dot{o}E_{i,req} and allocated state of energy rate S\dot{o}Eᵢ of the vehicle combination 100 are below a threshold. An optimisation function to minimise the cumulative power losses and state of energy rate difference may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {( {\dot{SoE}}_{i , req} - {\dot{SoE}}_{i} )}^{2} ) \qquad ( 5 )$$

The optimisation function in equation (5) serves to minimise the cumulative power losses from the units 110 of the vehicle combination 100 as well as minimising the difference between requested state of energy rate S\dot{o}E_{i,req} and the allocated state of energy rate S\dot{o}Eᵢ across the vehicle combination 100. By minimising the state of energy rate difference, it can be ensured that energy management, such as SoC of the various batteries 120, is properly performed. For example, the battery 120 of a unit 110 with higher SoC can be drained for an uphill slope, as batteries 120 of all units 110 can be charged fully with regenerative braking at a following downhill slope. This approach is disclosed in detail in PCT application no. PCT/EP2023/059643 filed on the same day as this application in the name of Volvo Truck Corporation.

The functions in equations (3), (4), and (5) can be combined to determine a force control input for a vehicle combination 100 based on the power losses, the force difference, and the state of energy rate difference of the vehicle combination 100.

The optimisation functions in equations (3), (4), and (5) may also include terms relating to a target value for the SoC of the batteries 120 and/or a target value for the power P_{batt i} delivered from the batteries 120. This serves to minimise the difference between the current SoC of the batteries 120 and/or the power delivered from the batteries 120 and respective target values. The power delivered from the batteries 120 can be considered during propulsion and regenerative braking respectively. The thermal recovery power from the service brakes 150 may also be considered. This approach is disclosed in detail in PCT applications no. PCT/EP2022/082326 and no. PCT/EP2022/082327 filed on 17 Nov. 2022 in the name of Volvo Truck Corporation.

The optimisation functions in equations (3), (4), and (5) may be subject to certain constraints. For example, it is ensured that the determined force control input Fₓ meets the reference force input F_{x,tot,req} for the vehicle combination 100. It may also be ensured that the optimisation function is constrained by the force capabilities u_{i,cap} of the units of the vehicle combination 100. It may also be ensured that the optimisation function is constrained by a safe operating envelope of the vehicle combination 100.

The optimisation functions in equations (3), (4), and (5) may also include weighting factors associated with each unit of the vehicle combination 100. The weighting factors can be set as 1 for the base case, but can be set appropriately in order to tune the optimisation functions for different outcomes. Setting them as zero will result in power loss minimisation. In one example, the use of the actuators for a particular unit 110 may be prioritised by setting a weighting factor for that unit with respect to the weighting factor of the other units (with a lower weighting factor underrepresenting the losses from that unit). One example where this may be appropriate is the case of a tractor unit 110-1 having an internal combustion engine (e.g. diesel) and an electric trailing unit 110-2. The weighting factors could be calculated based on current operating conditions, but also based on future operating conditions by receiving look-ahead information, for example from the tactical layer 204.

In another example, a force control input can be determined that provides an optimised power allocation for the vehicle combination 100. This approach is disclosed in detail in PCT application no. PCT/EP2022/082338 filed on 17 Nov. 2022 in the name of Volvo Truck Corporation, and is briefly summarised below.

This can be achieved by determining a power allocation input u_{comb,des} that is a set of desired motion parameters that satisfies a power allocation for the vehicle combination 100, determining a virtual combination control input v_{comb,req} describing the forces and/or moments that need to be applied to the vehicle combination 100 as a whole in order to follow the desired reference input Freq, and determining a true control input u_{comb} for the vehicle combination 100 that meets the desired motion parameters of the power allocation input u_{comb,des} and the virtual combination control input v_{comb,req}.

This may be achieved using an optimisation function to model different power allocations and determine which minimises the function. The optimisation functions may also be used to minimise the difference between the current SoC of the batteries and a target value, and to minimise the difference between the power delivered from the batteries and a target value. In one example, a weighted least squares optimisation problem is formulated as follows:

$${u}_{comb} = {arg min}_{\underline{{u}_{comb}} \leq {u}_{comb} \leq \overline{{u}_{comb}}} ( {‖ {W}_{u} ( {u}_{comb , des} - {u}_{comb} ) ‖}^{2} + ρ {‖ {W}_{v} ( {B}_{comb} {u}_{comb} - {v}_{comb , req} ) ‖}^{2} ) \qquad ( 6 )$$

where Wᵤ and Wᵥ are (positive definite) weighting matrices, ρ is a weighting factor, B_{comb} is a control efficiency matrix, and u_{comb} and u_{comb} are lower and upper capabilities of the various actuators, all defined and used as conventionally done in control allocation theory. The weighting factor ρ provides a trade-off between the power allocation term ∥Wᵤ(u_{comb,des}−u_{comb})∥² and the virtual control term ∥Wᵥ(B_{comb}u_{comb}−v_{comb,req})∥². When ρ→∞, the solution of the weighted least squares problem of equation (6) approaches that of a sequential least squares problem.

The approaches discussed above are intended to determine a force control input that satisfies a particular goal, for example minimisation of power losses. Within these solutions, a particular braking regime may be applied to the vehicle combination 100 for controlling braking of the units 110 of the vehicle combination 100. A braking regime results in a particular usage of the service brakes 150, and may be defined by a mapping between friction utilisation of different units 110, as will be explained below. However, the particular braking regime given by the approaches discussed above is constrained by the force control input that is provided and the constraints that were used to determine it, for example a safe operating envelope.

Usage of the brakes for a particular unit 110 can be described using a friction utilisation coefficient Cᵢ for the unit 110, given by:

$${C}_{i} = \frac{{F}_{x , i}}{μ \cdot {F}_{z , i}} \qquad ( 7 )$$

Where, for each unit i, F_{x,i} is the total longitudinal force applied at the axles of the unit, F_{z,i} is the total normal load at the axles of the unit, and u is the friction coefficient between the unit and the travelling surface. In an equal friction utilization scenario, it is desired that Cᵢ is the same for all units 110. That is to say, each unit i has a respective friction utilisation and the friction utilisations are equal across all units 110. This is the “conventional way of braking different units”, and is also safer than braking one unit alone or braking units at different levels. However, the approaches discussed above may not result in equal friction utilisation across at all units 110, especially in instances where only electrified units are braked. Furthermore, equal friction utilisation does not necessarily result in the most energy-efficient control of multi-unit electric vehicles, hence is not necessarily always preferred.

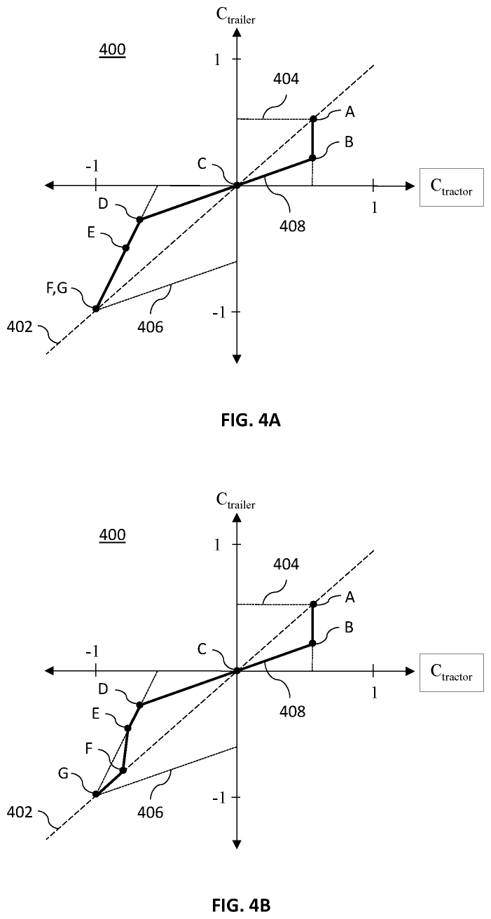

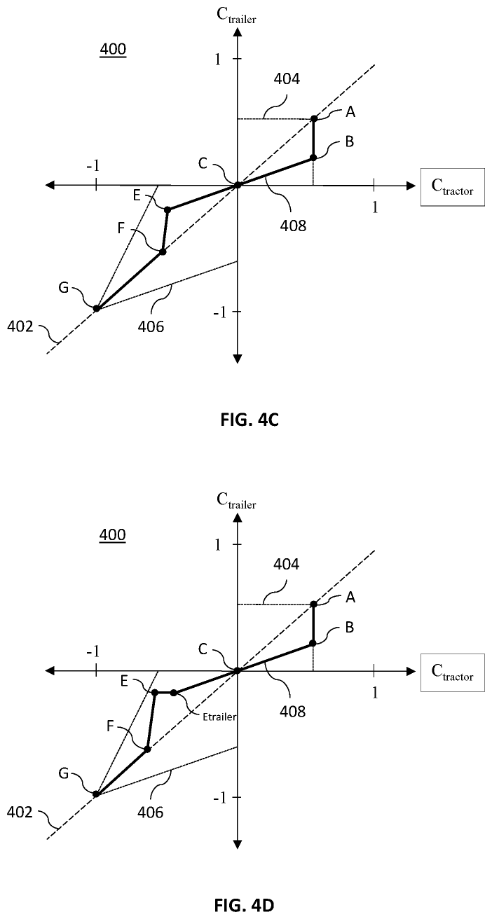

FIGS. 4A to 4D are example plots 400 of friction utilisation for a vehicle combination 100 comprising a tractor unit 110-1 and a semi-trailer trailing unit 110-2. The friction utilisation coefficient C_{tractor} for the tractor unit 110-1 is plotted on the x-axis, and the friction utilisation coefficient Cₜᵣₐᵢₗₑᵣ for the trailing unit 110-2 is plotted on the y-axis. The first (upper right) quadrant shows the propulsion case, where both units have positive friction utilisation. The third (lower left) quadrant shows the braking case, where both units have negative friction utilisation. The second and fourth quadrants, where one unit is propelled while the other brakes, are not considered. The diagonal dashed line 402 shows the equal friction utilisation case.

The dotted lines 404 in the first quadrant indicate a safe operating envelope for the vehicle combination 100 during propulsion, and the dotted lines 406 in the third quadrant indicate a safe operating envelope for the vehicle combination 100 during braking. These define limits on the friction utilisation coefficients for safe operation of the vehicle combination 100. In propulsion, the safe operating envelope is set at 0.5 for both friction utilisation coefficients, which ensures that some friction capacity remains (e.g. laterally) should it be required. In braking, the safe operating envelope is set to avoid the case where one unit is braked significantly more than the other, and so appears in the plot 400 as diagonal lines. It is possible to reach the full friction utilisation (−1, −1) for braking in order not to limit the crucial braking function, but not for propulsion (1, 1). This selection of safe operating envelopes is an example only, and there are other ways to implement safe operating envelopes that would be understood by the skilled person. Furthermore, lateral acceleration is considered constant, and the safe operating envelopes may change dependent on lateral acceleration. Typically, a higher the lateral acceleration will result in a tighter safe operating envelope will be, meaning that there is more lateral force capability remaining outside the safe operating envelope at high lateral accelerations.

The solid line 408 illustrates the friction utilisation for the vehicle combination 100 across different propulsion and braking scenarios. In particular, the solid line 408 follows the operating points for the friction utilisation in a particular scenario. Certain operating points A to F are indicated by dots. In particular:
Point A is where the friction utilisation is limited by the safe operating envelope for propulsion for the trailing unit 110-2, i.e. the maximum allowed friction utilisation coefficient Cₜᵣₐᵢₗₑᵣ for the trailing unit 110-2.
Point B is where the friction utilisation is limited by the safe operating envelope for propulsion for the tractor unit 110-1, i.e. the maximum allowed friction utilisation coefficient C_{tractor} for the tractor unit 110-1.
Point C is the zero braking case. In this disclosure, the friction utilisation always passes through this point as the case where one unit is propelled while the other brakes is not considered.
Point D is the point at which the friction utilisation is limited by the safe operating envelope for braking, i.e. the solid line 408 intersects one of the dotted lines 406.
Point E is the maximum capability for regenerative braking from the electrical machines 130, as will be discussed below.
Point F is the point at which the braking regime reaches equal friction utilisation, i.e. the line solid line 408 intersects the diagonal dashed line 402.
Point G is full friction utilisation, i.e. the friction utilisation coefficients C_{tractor} and Cₜᵣₐᵢₗₑᵣ are both −1.

Between points B and D, the control allocation is not yet limited by the safe operating envelope or the torque capabilities of the electrical machines 130. Here, an optimisation problem can be used, for example one of the optimisation problems discussed in relation to equations (3) to (6). The slope or shape of the line 408 between points B and D may vary dependent on the approach used to control motion of the vehicle combination 100.

The braking regime for the vehicle combination 100 is defined between points C and G (i.e. the part of the line 408 that is in the third quadrant). Between points C and E, only regenerative braking from the electrical machines 130 is used. Between points E and G, the service brakes 150 are also used. This is typically done when the regenerative braking capability of the vehicle combination 100 is reached, and more braking is requested.

Turning to FIG. 4A, a specific example is shown where a force control input is determined that satisfies a particular goal, for example minimisation of power losses, but does not provide equal friction utilisation. In the first quadrant, the safe operating envelope is reached first for the tractor unit 110-1 at point B. Then, if more propulsion force is requested, then only the trailing unit 110-2 propulsion force is increased while keeping the tractor unit 110-1 propulsion force constant until the safe operating envelope for the trailing unit 110-2 is also reached at point A. It will be appreciated that, in some examples, the safe operating envelope may be reached for the trailing unit 110-2 before that for the for the tractor unit 110-1 (i.e. point A is reached before point B). In some examples, the safe operating envelope can be beyond the positive force capabilities of the units 110, meaning that points A and B would both be within the lines 404.

In the third quadrant, the safe operating envelope is reached at point D. Then, if more braking force is requested, this is done on the limits of the safe operating envelope, i.e. the line 408 follows the line 406. At point E, the regenerative capabilities of the electrical machines 130 are reached. In this case, the regenerative braking capabilities of the electrical machines 130 of both units 110-1, 110-2 are reached at the same time, although it will be appreciated that these capabilities may be met at different times for different units. Then, if more braking force is requested, this is done using the service brakes 150, still on the limits of the safe operating envelope. This continues until full friction utilisation is achieved at point G.

In particular, it is noted that the braking regime does not reach equal friction utilisation until the maximum braking force is achieved (i.e. points F and G coincide). Therefore, a solution is required that can enable equal friction utilisation.

An example of this is shown in FIG. 4B. Here, a first braking regime is defined until the regenerative braking capabilities of the electrical machines 130 are reached (between points C and E). In the first braking regime, one of the optimisation problem approaches to vehicle control is used, as discussed above. A second braking regime is defined at which equal friction utilisation is enforced by using the service brakes 150 to bring the vehicle combination 100 into equal friction utilisation (between points F and G). This enables safer operation of the vehicle combination 100 as friction utilisation is balanced across the units 110. In the second braking regime, equal friction utilisation is prioritised and the optimisation problem used in the first braking regime is no longer strictly followed. In this example, point F brings the vehicle combination 100 into equal friction utilisation before full friction utilisation is reached at point G. This leaves further lateral and longitudinal force capability available should it be needed.

It can be seen that a transition is determined between the two regimes (between points E and F). The determination of the transition will be described later. In this instance, the transition is achieved by increasing the friction utilisation of the trailing unit 110-2 (i.e. increasing braking of the trailing unit 110-2), however it will be appreciated that, had the first braking regime been on the other side of the line 402, then the transition would be achieved by increasing the friction utilisation of the tractor unit 110-1 (i.e. increasing braking of the tractor unit 110-1).

FIG. 4C shows another example where equal friction utilisation is enforced. Here, the regenerative braking capabilities of the electrical machines 130 are reached before the first braking regime is limited by the safe operating envelope. As such, there is no point D on the plot 400 of FIG. 4C.

FIG. 4D shows an example where, in the first braking regime, the regenerative braking capabilities of the electrical machines 130 of the tractor unit 110-1 and the trailing unit 110-2 are reached at different times. In particular, a point Eₜᵣₐᵢₗₑᵣ is defined that represents the maximum regenerative braking capability of the trailing unit 110-2. After this point, braking of the trailing unit 110-2 is constant while regenerative braking of the tractor unit 110-1 increases unit its capability is reached at point E. Then, a transition is determined between points E and F and equal friction utilisation is enforced between points F and G. It will be appreciated that, in some examples, the regenerative braking capabilities of the tractor unit 110-1 may be reached before the regenerative braking capabilities of the trailing unit 110-2, in which case a point E_{tractor} may be defined that represents the maximum regenerative braking capability of the tractor unit 110-1.

FIGS. 4A to 4D are example plots 400 of friction utilisation for a vehicle combination 100 comprising an electrically driven tractor unit 110-1 and trailing unit 110-2. As such, the plots 400 have two dimensions. As discussed above, vehicle combinations 100 may have any suitable number or type of units 110, and it will be appreciated that the dimension of such plots 400 will increase with the number of units 110.

In the examples of FIGS. 4A to 4D, the first braking regime is ended when the regenerative braking capabilities of the electrical machines 130 of both units 110-1, 110-2 are reached, and the service brakes 150 are used to bring the vehicle combination 100 into equal friction utilisation in the second braking regime. In some examples, the first braking regime may be ended earlier (i.e. before the regenerative braking capabilities of the electrical machines 130 are reached). For example, an ongoing or upcoming yaw or roll instability may be determined using a vehicle model, as discussed above. When an ongoing or upcoming instability is detected, this may trigger the control allocation to transition from the first braking regime to the second braking regime. This can help to avoid an ongoing or upcoming yaw or roll instability, as the equal friction utilisation case is the safest mode of braking the vehicle combination 100. In some examples, the first braking regime may be ended when the optimisation problem is limited by the safe operating envelope (at point D), after which the second braking regime may be initiated.

In the examples of FIGS. 4B to 4D, there is a transition between the first and second braking regimes. These transitions enable a smooth change between the first and second braking regimes, meaning that the force request does not jump between discrete values, which can cause various issues in vehicle motion.

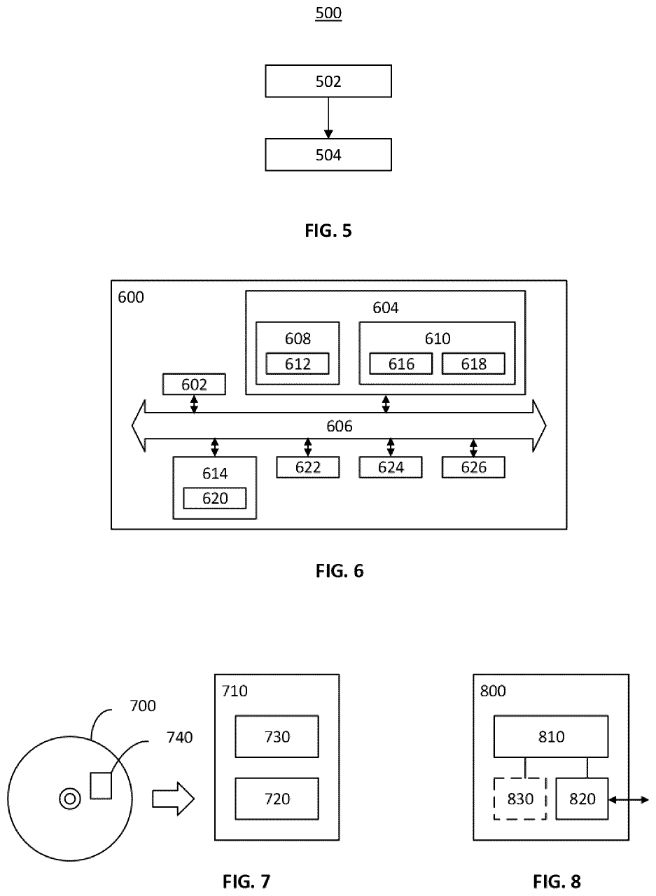

FIG. 5 is a flowchart of an example method 500 for controlling braking of a vehicle combination 100. In some examples, braking of the vehicle combination 100 can be controlled by determining a force control input for the vehicle combination 100 comprising a longitudinal braking force input for each unit 110. The force control input results in a friction utilisation for each unit which is used to define braking regimes for the combination 100. The method 500 is a computer-implemented method, performed for example by the control system 200 of a vehicle combination 100.

At 502, a first braking regime is determined for each unit 110 of the vehicle combination 100. The first braking regime is determined using an optimisation function that is configured to determine a force control input for the vehicle combination 100. This may be any of the optimisation functions discussed in relation to equations (3) to (6). For example, the optimisation function may be configured to determine a force control input such that a cumulative power loss of the vehicle combination 100 is below a threshold. The optimisation function may be constrained by a safe operating envelope of the vehicle combination 100, and/or may comprise weighting factors associated with each unit of the vehicle combination 100, as discussed above.

The first braking regime is applicable from the beginning of braking (indicated by point C in FIGS. 4A to 4D) until a certain point. In some examples, the first braking regime is applicable until the regenerative braking capabilities of the electrical machines 130 of all units 110 of the vehicle combination 100 are reached (indicated by point E in FIGS. 4A to 4D). In some examples, the first braking regime is applicable until the optimisation function is limited by the safe operating envelope (indicated by point D in FIGS. 4A to 4D). The first braking regime may be applied using only regenerative braking by the electrical machines 130 of the vehicle combination 100.

At 504, a second braking regime is determined. In the second braking regime, the friction utilisation of each unit 110 is equal. That is to say, Cᵢ is the same for all units 110 of the vehicle combination 100. The second braking regime can be determined in a number of ways, as will be described later.

The second braking regime is applicable when the limit of the first braking regime is reached until full friction utilisation. As discussed above, the limit of the first braking regime may be the point at which the regenerative braking capabilities of the electrical machines 130 of all units 110 of the vehicle combination 100 are reached or the point at which the optimisation function is limited by the safe operating envelope. The second braking regime may be applied using the service brakes 150 of the vehicle combination in addition to regenerative braking by the electrical machines 130 of the vehicle combination 100. Full friction utilisation is the point at which all braking systems have reached their capability (indicated by point G in FIGS. 4A to 4D). At this point, the friction utilisation of all units 110 is −1.

The second braking regime, and any transition between the first braking regime and the second braking regime, can be determined in a number of ways. In some examples, this can be achieved by adding constraints to the optimisation function used to determine the first braking regime. In other examples, the optimisation function itself can be adjusted to determine the second braking regime.

In a first approach, determining the second braking regime comprises constraining the optimisation function such that the friction utilisation of each unit 110 is equal. In particular, this can be achieved by using an additional equality constraint with the optimisation function, as follows:

$$[ \begin{matrix}\frac{1}{{F}_{z}^{tractor}} & \frac{1}{{F}_{z}^{tractor}} & \frac{- 1}{{F}_{z}^{trailer}} & \frac{- 1}{{F}_{z}^{trailer}}\end{matrix} ] {F}_{x} = 0 \qquad ( 8 )$$

$${F}_{x} = [ {F}_{xp 1} , {F}_{xb 1} , {F}_{xp 2} , {F}_{xb 2} , ... , {F}_{xpn} , {F}_{xbn} ] \qquad ( 9 )$$

where Fₓₚᵢ is the longitudinal part of the force applied by the unit's propulsion system, and F_{xbi} is the longitudinal part of the force applied by the unit's braking system. Note that, to simplify the equations, braking of non-driven axles is not considered in this allocation. Put otherwise,

$${F}_{z}^{tractor} and {F}_{z}^{trailer}$$

are the driven axle loads of the units and it is assumed that all axles are driven. Braking of non-driven axles can easily be added by the person skilled in the art.

The constraint defined in equations (8) and (9) will ensure that the friction utilisation of each unit 110 is equal. That is to say, the line 408 in FIGS. 4A to 4D will follow the diagonal line 402. This is therefore applicable between points F and G in FIGS. 4A to 4D. However, it may also be necessary to determine a transition between the first and second braking regimes, as shown between points E and F in FIGS. 4B to 4D.

In some examples, this can be achieved using linear interpolation. Linear interpolation techniques are well known in the art and will not be described here. In other examples, the transition can be determined by constraining the optimisation function such that the difference between the friction utilisations of each unit tends to zero 110. In particular, this can be achieved by using an additional equality constraint with the optimisation function, as follows:

$$[ \begin{matrix}\frac{1}{{F}_{z}^{tractor}} & \frac{1}{{F}_{z}^{tractor}} & \frac{- 1}{{F}_{z}^{trailer}} & \frac{- 1}{{F}_{z}^{trailer}}\end{matrix} ] {F}_{x} = X \qquad ( 10 )$$

where X is non-zero and changes over time. In particular, X may be defined as non-zero at the limit of the first braking regime (e.g. point E), and tend to zero as the transition approaches equal friction utilisation (at point F), at which point the constraint in equation (8) is used.

The equality constraints in equations (8) and (10) may also be adapted to ensure that the constraints discussed above are also met. In particular, it should be ensured that the determined force control input meets the reference force input for the vehicle combination 100 and that the optimisation function is constrained by the force capabilities of the units of the vehicle combination 100. How this may be achieved will be understood by the person skilled in the art.

In a second approach, determining the second braking regime comprises adjusting the optimisation function itself. In particular, the optimisation function can be used to determine a force control input such that a difference between the friction utilisation of each unit 110 is below a threshold. This can be achieved by adding a term to the optimisation function.

Taking the example of the power loss minimisation function of equation (3), a term relating the friction utilisation of each unit 110 can be included as follows:

$${min}_{{F}_{x}} {\sum }_{i = 1}^{n} ( {P}_{pi , loss} ( {F}_{xpi} ) + {P}_{bi , loss} ( {F}_{xbi} ) ) + γ \cdot {\sum }_{i = 1}^{n - 1} ( \frac{{F}_{xpi} + {F}_{xbi}}{{F}_{zi}} - \frac{{F}_{xp ( i + 1 )} + {F}_{xb ( i + 1 )}}{{F}_{z ( i + 1 )}} ) \qquad ( 11 )$$

where γ changes over time. In particular, y is set at zero at the limit of the first braking regime (e.g. point E), increases as the transition approaches equal friction utilisation (at point F), and becomes very large as equal force utilisation is applied (until point G). Between points F and G, γ may be constant or may increase, and this can be tuned by the user for a particular scenario. However, if γ becomes too large, there becomes a risk that the power loss terms become so small that the electrical machines 130 are not fully utilised, and so it may be considered preferable to keep y constant between points F and G.

The first set of terms in equation (11) corresponds to equation (3) and serves to minimise power losses across the vehicle combination 100 in the first braking regime as discussed above. The second set of terms in equation (12) is for equal friction utilisation across the units 110, and determines both the second braking regime and the transition between the braking regimes. Once again, to simplify the equations, braking of non-driven axles is not considered in this allocation, but can easily be added by the person skilled in the art.

The disclosed approach enables a control input to be tailored in some specific way whilst also providing a safe braking regime where necessary, as equal friction utilisation is considered safer than braking one unit alone or braking units at different levels. For example, a force control input can be determined that minimises power losses, whilst equal friction utilisation can be prioritised when considered necessary. This enables safer operation of the vehicle combination as friction utilisation is balanced across the units. Providing a smooth transition between braking regimes enables step-like jumps in force requests to be avoided. The switch between braking regimes can be triggered based on energy recovery or safety demands.

FIG. 6 is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilised with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system 600 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The described examples and their equivalents may be realized in software or hardware or a combination thereof. The examples may be performed by general purpose circuitry. Examples of general purpose circuitry include digital signal processors (DSP), central processing units (CPU), co-processor units, field programmable gate arrays (FPGA) and other programmable hardware. Alternatively or additionally, the examples may be performed by specialized circuitry, such as application specific integrated circuits (ASIC). The general purpose circuitry and/or the specialized circuitry may, for example, be associated with or comprised in an electronic apparatus such as a vehicle control unit.

The electronic apparatus may comprise arrangements, circuitry, and/or logic according to any of the examples described herein. Alternatively or additionally, the electronic apparatus may be configured to perform method steps according to any of the examples described herein.

According to some examples, a computer program product comprises a non-transitory computer readable medium such as, for example, a universal serial bus (USB) memory, a plug-in card, an embedded drive, or a read only memory (ROM). FIG. 7 illustrates an example computer readable medium in the form of a compact disc (CD) ROM 700. The computer readable medium has stored thereon a computer program 740 comprising program instructions. The computer program is loadable into a data processor (e.g., a data processing unit) 920, which may, for example, be comprised in a vehicle control unit 710. When loaded into the data processor, the computer program may be stored in a memory 730 associated with, or comprised in, the data processor. According to some examples, the computer program may, when loaded into, and run by, the data processor, cause execution of method steps according to, for example, any of the methods described herein.

FIG. 8 schematically illustrates, in terms of a number of functional units, the components of a control unit 800 according to some examples. The control unit may be comprised in a vehicle, e.g., in the form of a vehicle motion management (VMM) unit. A processor device in the form of processing circuitry 810 is provided using any combination of one or more of a suitable central processing unit (CPU), multiprocessor, microcontroller, digital signal processor (DSP), or similar; capable of executing software instructions stored in a computer program product, e.g. in the form of a storage medium 830. The processing circuitry 1010 may further be provided as at least one application specific integrated circuit ASIC, or field programmable gate array FPGA.

Particularly, the processing circuitry 810 is configured to cause the control unit 1000 to perform a set of operations, or steps; for example, the methods discussed in connection with FIG. 5.

For example, the storage medium 830 may store a set of operations, and the processing circuitry 810 may be configured to retrieve the set of operations from the storage medium 830 to cause the control unit 800 to perform the set of operations. The set of operations may be provided as a set of executable instructions. Thus, the processing circuitry 1010 is thereby arranged to execute methods as herein disclosed.

The storage medium 830 may comprise persistent storage, which, for example, can be any single one or combination of magnetic memory, optical memory, solid state memory or even remotely mounted memory.

The control unit 800 may further comprise an interface 820 for communication with at least one external device. As such, the interface 820 may comprise one or more transmitters and receivers, comprising analogue and digital components and a suitable number of ports for wireline or wireless communication.

The processing circuitry 810 controls the general operation of the control unit 800, e.g., by sending data and control signals to the interface 820 and the storage medium 830, by receiving data and reports from the interface 820, and by retrieving data and instructions from the storage medium 830. Other components, as well as the related functionality, of the control node are omitted in order not to obscure the concepts presented herein.

In some examples, the control unit 800 may be seen as a control system, or may be comprised in a control system. The control system may be configured for vehicle motion management (VMM).

According to certain examples, there is also disclosed:
Example 1. A computer-implemented method (500) for controlling braking of a vehicle combination (100) comprising a tractor unit and at least one trailing unit, the method comprising:
   determining (502) a first braking regime for controlling braking of each unit (110) of the vehicle combination using an optimisation function configured to determine a force control input for the vehicle combination; and
   determining (504) a second braking regime for controlling braking of each unit of the vehicle combination in which each unit has a respective friction utilisation and the friction utilisations are equal.
Example 2. The computer-implemented method (500) of claim 1, wherein determining (504) the second braking regime comprises applying a constraint to the optimisation function that the friction utilisations are equal.
Example 3. The computer-implemented method (500) of claim 1 or 2, further comprising determining a transition between the first and second braking regimes using linear interpolation.
Example 4. The computer-implemented method (500) of claim 1 or 2, further comprising determining a transition between the first and second braking regimes by applying a constraint to the optimisation function that a difference between the respective friction utilisations tends to zero.
Example 5. The computer-implemented method (500) of claim 1, wherein determining (504) the second braking regime comprises using the optimisation function such that a difference between the friction utilisation of each unit is below a threshold.
Example 6. The computer-implemented method (500) of claim 5, further comprising determining a transition between the first and second braking regimes by using the optimisation function such that a difference between the respective friction utilisations tends to zero.
Example 7. The computer-implemented method (500) of any preceding claim, wherein the first braking regime is configured to be applied using only electric machine braking of the vehicle combination (100).
Example 8. The computer-implemented method (500) of any preceding claim, wherein the second braking regime is configured to be applied using electric machine braking and service brakes (150) of the vehicle combination (100).
Example 9. The computer-implemented method (500) of any preceding claim, wherein the first braking regime is applicable until the braking capacity of electrical machines (130) of all units (110) has been reached.
Example 10. The computer-implemented method (500) of any preceding claim, wherein the first braking regime is applicable until a safe operating envelope for the vehicle combination (100) has been reached.
Example 11. The computer-implemented method (500) of any preceding claim, wherein the second braking regime is applicable until full friction utilisation for the vehicle combination (100) has been reached.
Example 12. The computer-implemented method (500) of any preceding claim, further comprising determining the force control input for the vehicle combination (100) comprising a longitudinal braking force input for each unit (110).
Example 13. The computer-implemented method (500) of any preceding claim, wherein the optimisation function is configured to determine the force control input such that a cumulative power loss of the vehicle combination (100) is below a threshold.
Example 14. The computer-implemented method (500) of any preceding claim, wherein the optimisation function comprises weighting factors associated with each unit of the vehicle combination (100).
Example 15. The computer-implemented method (500) of any preceding claim, wherein the friction utilisation, Cᵢ, for a unit is given by:

$${C}_{i} = \frac{{F}_{x , i}}{μ \cdot {F}_{z , i}}$$

Where, for each unit i, F_{x,i} is a total longitudinal force applied at the axles of the unit, F_{z,i} is a total normal load at the axles of the unit, and μ is the friction coefficient between the unit and the travelling surface.
Example 16. A vehicle combination (100) comprising a tractor unit and at least one trailing unit, the vehicle combination comprising processing circuitry to perform the computer-implemented method (500) of any of claims 1 to 15.
Example 17. A computer program product comprising program code for performing, when executed by processing circuitry, the computer-implemented method (500) of any of claims 1 to 15.
Example 18. A control system comprising one or more control units configured to perform the computer-implemented method (500) of any of claims 1 to 15.
Example 19. A non-transitory computer-readable storage medium comprising instructions, which when executed by processing circuitry, cause the processing circuitry to perform the computer-implemented method (500) of any of claims 1 to 15.
Example 20. A computer system comprising processing circuitry configured to perform the computer-implemented method (500) of any of claims 1 to 15.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealised or overly formal sense unless expressly so defined herein.

It is to be understood that the present disclosure is not limited to the aspects described above and illustrated in the drawings; rather, the skilled person will recognise that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer-implemented method for controlling braking of a vehicle combination comprising a tractor unit and at least one trailing unit, the method comprising:
determining a first braking regime for controlling braking of each unit of the vehicle combination using an optimisation function configured to determine a force control input for the vehicle combination; and
determining a second braking regime for controlling braking of each unit of the vehicle combination in which each unit has a respective friction utilisation and the friction utilisations are equal.

2. The computer-implemented method of claim 1, wherein determining the second braking regime comprises applying a constraint to the optimisation function that the friction utilisations are equal.

3. The computer-implemented method of claim 1, further comprising determining a transition between the first and second braking regimes using linear interpolation.

4. The computer-implemented method of claim 1, further comprising determining a transition between the first and second braking regimes by applying a constraint to the optimisation function that a difference between the respective friction utilisations tends to zero.

5. The computer-implemented method of claim 1, wherein determining the second braking regime comprises using the optimisation function such that a difference between the friction utilisation of each unit is below a threshold.

6. The computer-implemented method of claim 5, further comprising determining a transition between the first and second braking regimes by using the optimisation function such that a difference between the respective friction utilisations tends to zero.

7. The computer-implemented method of claim 1, wherein the first braking regime is configured to be applied using only electric machine braking of the vehicle combination.

8. The computer-implemented method of claim 1, wherein the second braking regime is configured to be applied using electric machine braking and service brakes of the vehicle combination.

9. The computer-implemented method of claim 1, wherein the first braking regime is applicable until the braking capacity of electrical machines of all units has been reached.

10. The computer-implemented method of claim 1, wherein the first braking regime is applicable until a safe operating envelope for the vehicle combination has been reached.

11. The computer-implemented method of claim 1, wherein the second braking regime is applicable until full friction utilisation for the vehicle combination has been reached.

12. The computer-implemented method of claim 1, further comprising determining the force control input for the vehicle combination comprising a longitudinal braking force input for each unit.

13. The computer-implemented method of claim 1, wherein the optimisation function is configured to determine the force control input such that a cumulative power loss of the vehicle combination is below a threshold.

14. The computer-implemented method of claim 1, wherein the optimisation function comprises weighting factors associated with each unit of the vehicle combination.

15. The computer-implemented method of claim 1, wherein the friction utilisation, Cᵢ, for a unit is given by:
$${C}_{i} = \frac{{F}_{x , i}}{μ \cdot {F}_{z , i}}$$
Where, for each unit i, F_{x,i} is a total longitudinal force applied at the axles of the unit, F_{z,i} is a total normal load at the axles of the unit, and u is the friction coefficient between the unit and the travelling surface.

16. A vehicle combination comprising a tractor unit and at least one trailing unit, the vehicle combination comprising processing circuitry to perform the computer-implemented method of claim 1.

17. A computer program product comprising program code for performing, when executed by processing circuitry, the computer-implemented method of claim 1.

18. A control system comprising one or more control units configured to perform the computer-implemented method of claim 1.

19. A non-transitory computer-readable storage medium comprising instructions, which when executed by processing circuitry, cause the processing circuitry to perform the computer-implemented method of claim 1.

20. A computer system comprising processing circuitry configured to perform the computer-implemented method of claim 1.
